(19) United States
(12) Patent Application Publication
(10) Pub. No.: US 2015/0144526 A1
(43) Pub. Date: May 28, 2015

(54) FISCHER-TROPSCH DERIVED HEAVY HYDROCARBON DILUENT

(71) Applicant: Sasol Technology (Pty) Ltd, Johannesburg (ZA)

(72) Inventors: Andre Swart, Katy, TX (US); Jerry Joseph Krett, Calgary (CA); Nico Esterhuyse, Briza (ZA)

(21) Appl. No.: 14/402,305

(22) PCT Filed: May 21, 2013
(86) PCT No.: PCT/ZA2013/000036

§ 371 Date: Nov. 19, 2014

(30) Foreign Application Priority Data
May 22, 2012 (ZA) 2012/03725

(51) Int. Cl. F17D 1/17; C10G 2/00

(52) U.S. Cl. CPC F17D 1/17; C10G 2/00
USPC 208/14

(57) ABSTRACT

The invention provides a process for making a heavy hydrocarbon feed pipeline transportable, said process including blending the heavy hydrocarbon feed with a diluent including a hydrocarbon stream having at least 0.5% by mass of a C₄ or lighter hydrocarbon component, said diluent having less than 2% by volume aromatics, wherein the viscosity of the heavy hydrocarbon feed and diluent blend is below 500 cSt at 7.5° C. which is within pipeline transportable limits.

### FIELD OF THE INVENTION

The invention relates to a process in which hydrocarbons produced by a Fischer Tropsch process are blended with heavier hydrocarbon streams in order to facilitate transportation of the heavier hydrocarbon streams, more specifically the Fischer Tropsch derived hydrocarbons of this invention is suitable as a diluent for heavy hydrocarbons.

### BACKGROUND OF THE INVENTION

Certain heavy hydrocarbon deposits, such as the oil sands found in Western Canada, require significant refining to render them suitable for use as fuel or as another conventional crude-derived product. Oil sands are essentially deposits of heavy, highly viscous hydrocarbons with a very high resin and asphaltene content. The chemical nature of the heavy hydrocarbons renders them difficult to extract, transport and upgrade. This is exacerbated by the fact that they are typically located in regions that are very remote from the refineries that can upgrade them. If they are to be transported effectively by pipeline to an upgrading facility, their viscosity must be effectively reduced by either blending with an externally sourced, lower viscosity liquid (diluent); or upgrading a portion of the heavy hydrocarbon itself in situ to produce a suitable carrier stream.

Ideally, diluents are used to reduce the viscosity of the heavy hydrocarbon stream (eg. bitumen) to the point where the diluted heavy hydrocarbon can be injected into and transported in a standard (non-heated) pipeline. The biggest risk when employing a diluent is that any chemical incompatibility between the bitumen and diluent species can lead to the precipitation of asphaltene solids, which could have a significant operational impact on pipeline operation. This precipitation occurs when the asphaltene molecules, which occur as a colloidal suspension, become destabilised then flocculate and agglomerate.

Hence the choice of suitable diluent chemistry requires that sufficient diluent be accommodated to reduce the viscosity to below the practical pipeline limits (for example less than 350 cSt at 7.5° C.) whilst still retaining the stability of the asphaltene colloids that comprise much of the heavy hydrocarbon stream.

U.S. Pat. No. 7,491,314 discloses the partial upgrading of a portion of the heavy hydrocarbon stream itself. This upgraded stream is used as an in situ diluent stream to make the heavy hydrocarbon pipeline-transportable and also generate some power/heat for the extraction process.

U.S. Pat. No. 6,531,516 discloses the use of GTL-derived naphtha as a suitable diluent for heavy hydrocarbons as part of entire integrated bitumen and gas conversion process. It clearly teaches that the diluent includes hydrocarbons in the range beginning from C₅ up to as high as 213-232° C.

U.S. Pat. No. 6,277,269 teaches the production of pipelineable bitumen by an improvement in modifying the density and viscosity so as to meet pipeline specification, the improvement including subjecting a heavy hydrocarbon to hydroconversion under conditions to modify the viscosity and adding a diluent to the modified hydrocarbon.

### SUMMARY OF THE INVENTION

According to one aspect of the invention there is provided a process for making a heavy hydrocarbon feed pipeline transportable, said process including blending the heavy hydrocarbon feed with a diluent including a hydrocarbon having at least 0.5% by mass of a C₄ or lighter hydrocarbon component, said diluent having less than 2% by volume aromatics, wherein the viscosity of the heavy hydrocarbon feed and diluent blend is below 500 cSt at 7.5° C. which is within pipeline transportable limits.

The hydrocarbon of the diluent may be Fischer Tropsch (FT) derived.

The diluent may be a blend of the Fischer Tropsch (FT) derived hydrocarbon and at least 0.5% by mass of the C₄ or lighter hydrocarbon component.

The diluent may have an aromatics content less than 1% by volume.

The diluent may have an aromatics content less than 0.1% by volume.

The FT-derived hydrocarbon may be a naphtha.

The FT-derived hydrocarbon may be a diesel.

The diluent may have at least 2% by mass of a C4 or lighter hydrocarbon component.

The diluent may contain no more than 5% by mass of a C₄ or lighter hydrocarbon component.

The C₄ or lighter hydrocarbon component may be derived from a FT process.

According to a second aspect of the invention there is provided a FT-derived hydrocarbon suitable for use as a heavy hydrocarbon diluent that includes at least 0.5% by mass of a C₄ or lighter hydrocarbon component to produce a blend having a viscosity of less than 500 cSt at 7.5° C.

The FT-derived hydrocarbon includes no more than 5% by mass of a C₄ or lighter hydrocarbon component.

Typically to be pipeline transportable a heavy hydrocarbon feed should have a viscosity of below 500 cSt at 7.5° C., generally below 350 cSt at 7.5° C.

### DETAILED DESCRIPTION OF THE INVENTION

The inventors have found that, contrary to what was expected, it is possible to blend up to 5% of a light hydrocarbon fraction (C₄ and lighter) with FT-derived naphtha; and still obtain a product that is highly suitable for use as a heavy hydrocarbon diluent. This finding is surprising because the expectation was that incorporating significant levels of light hydrocarbons (C₄ and less) without the significant presence of aromatic species (normally required at, for example, levels of at least 2% by volume) would result in substantial asphaltene incompatibility; caused by the considerable molecule size mismatch between these very light hydrocarbons and the asphaltene molecules.

This finding that an FT-derived diluent for bitumen can be produced by blending in up to 5% by mass of butane (or a similar light hydrocarbon component that is predominantly equal to or less than C₄) with the naphtha or diesel cut, without causing incompatibility has significant commercial implications. It enables the use of a broader spectrum of the lighter hydrocarbons produced by the FT process; and also enables a more effective reduction in the density of the diluent, in order to improve the ratio on blending into the heavy hydrocarbon stream.

As defined in U.S. Pat. No. 7,491,314, a pipeline-transportable hydrocarbon feed is able to be transported by pipeline over considerable distances (usually over 500 km, but even in excess of 1000 km). This should occur with reasonable energy expenditure in terms of pumping and infrastructure requirements. In the context of this invention, a current upper viscosity threshold for pipeline injection would be approximately 350 cSt at 7.5° C. It should be noted that this threshold could shift depending on the exact technology conditions involved for the pipeline transportation system.

### Fischer Tropsch (FT) Process

FT synthesis can be used at two temperature ranges: (i) the so-called Low Temperature Fischer-Tropsch (LTFT) process, typically below 300° C., and (ii) the so-called High Temperature Fischer-Tropsch (HTFT) process, typically above 300° C.

The FT process is used industrially to convert synthesis gas, derived from coal, natural gas, biomass or heavy oil streams, into hydrocarbons ranging from methane to species with molecular masses above 1400. While the main products of the FT process are linear paraffinic materials; other species such as branched paraffins, olefins and oxygenated components form part of the product slate. The exact product slate depends on reactor configuration, operating conditions and the catalyst that is employed, as is evident from e. g. Catal. Rev.-Sci. Eng., 23 (1 & 2), 265-278 (1981).

Preferred reactors for the production of heavier hydrocarbons are slurry bed or tubular fixed bed reactors, while operating conditions are preferably in the range of 160-280° C., in some cases 210-260° C.; and 18-50 Bar, in some cases 20-30 bar. Preferred active metals in the catalyst comprise iron, ruthenium or cobalt. While each catalyst will give its own unique product slate; in all cases, the product slate contains some waxy, highly paraffinic material which needs to be further upgraded into usable products.

The FT products can be converted into a range of products, such as naphtha, middle distillates, etc.

Such conversion usually consists of a range of processes such as hydrocracking, hydrotreatment and distillation.

### Heavy Hydrocarbon Feed

Heavy hydrocarbon feeds suitable for use in the practise of the invention are those that contain a substantial portion with a boiling point greater than about 525° C. Of particular interest are the heavy hydrocarbon oils that can be extracted from sources such as the Athabasca and Cold Lake oil sands. Such heavy hydrocarbons will be extremely viscous, typically having a viscosity at 80° C. in excess of 500 cSt.

Table 1, following, gives some basic properties of representative heavy hydrocarbon, Mackay River bitumen.

TABLE 1
Mackay River Bitumen

| Element | Result | Units |
|---|---|---|
| DENSITY 15.6° C. | 1.0108 | g/ml |
| DENSITY 15° C. | 1008.3 | Kg/m³ |
| WATER CONTENT | 0.040 | wt % |
| TOTAL SULPHUR CONTENT | 4.74 | wt % |
| VISCOSITY @ 80° C. | 592.8 | cSt |
| VISCOSITY @ 100° C. | 205.8 | cSt |
| MICROCARBON RESIDUE | 13.0944 | wt % |
| TOTAL ACID NUMBER | 2.823 | mg KOH/g |
| SARA ANALYSIS | — | — |
| SATURATES | 15.5 | wt % |
| AROMATICS | 53.34 | wt % |
| RESINS | 12.8 | wt % |
| ASPHALTENES(PENTANE | 18.359 | wt % |
| INSOLUBLES) | | |
| WIEHE SOLUBILITY NUMBER | 95.58 | n/a |
| WIEHE INSOLUBILITY NUMBER | 31.65 | n/a |
| P-VALUE | 3.02 | n/a |
| CARBON CONTENT | 83.9 | wt % |
| HYDROGEN CONTENT | 10.65 | wt % |
| NITROGEN CONTENT | 0.4 | wt % |

### FT-Derived Hydrocarbon Stream

FT-derived hydrocarbon streams that are suitable for use as a diluent in the practise of this invention may be selected from:
naphtha which includes hydrocarbons boiling in the range from C₅ up to approximately 230° C.; where a light naphtha typically boiling in the range from C₅ up to about 160° C. and a heavy naphtha typically boiling in the range from 130° C. up to about 230° C. would be suitable;
a middle distillate fraction which includes hydrocarbons boiling in the range from 120° C. up to approximately 370° C.;
blends of suitable hydrocarbons boiling in the naphtha and middle distillate ranges.

The naphtha has the lowest viscosity and is hence typically preferred for use to dilute the bitumen for pipeline transportation. In the case of this invention, Gas-to-Liquids (GTL) FT processes are typically preferred because of the plentiful supply of natural gas that is usually found in or near tar sand formations.

Table 2, following, gives typical characteristics of such a suitable GTL FT-derived naphtha.

TABLE 2

| | | | | SPECS | |
|---|---|---|---|---|---|
| PARAMETER | METHOD | RESULT | UNITS | Min | Max |
| Density @ 15° C. | ASTM D4052 | 678.8 | kg/m³ | 600 | 775 |
| Viscosity @ 7.5° C. | ASTM D445 | 0.63 | cSt | — | 2.0 |
| Sulfur, total | ASTM D5453 | 0.0001 | wt % | — | 0.5 |
| Olefins, total | ASTM D6729 (260° C. cut) | 0.19 | wt% | — | <1 |
| Reid Vapour Pressure | ASTM D323 | 49 | kPa | — | 103 |
| BS&W | ASTM D95 | 0.003 | mass % | — | 0.5 |
| Organic Chlorides | ASTM D4929 (204° C. cut) | <1 | wppm | — | <1 |
| Aromatics, total BTEX | ASTM D6729 (260° C. cut) | 0.040 | vol % | 2.0 | — |
| Mercaptans, volatile (C1, C2, C3) | ASTM D5623 | <0.5 | wppm | — | 175 |
| H2S (in liquid phase) | ASTM D5623 | <0.5 | wppm | — | 20 |
| Benzene | ASTM D6729 (260° C. cut) | <0.01 | vol % | — | 1.6 |
| Mercury | UOP 938 (CVAA) | <10 | wppb | — | 10 |
| Oxygenates | ASTM D6729 (260° C. cut) | <100 | wppm | — | 100 |
| Filterable Solids | ASTM D4807 (procedure C) | 3.0 | mg/L | — | 200 |
| Phosphorous, volatile | ASTM D5708 | <0.5 | ppm | — | — |
| Selenium | ASTM D5807A (ICPMS) | 1 | wppb | — | — |
| Pour Point | ASTM D97 | <−65 | ° C. | — | — |
| Salt Content | ASTM D3230 | <0.1 | ptb | — | — |
| SimDist | ASTM D2887 | See Attached | vol % | — | — |

Remarks
RVP performed by ASTM D323

Table 3 gives further characteristics of various types of suitable GTL naphtha that may be derived from an FT process. For example:
straight run naphtha (designated SR) which is naphtha derived directly from the FT process product by fractionation
hydrotreated straight run (designated HSR) naphtha which is SR naphtha that has been hydrotreated to reduce the content of olefinic and oxygenated compounds
hydrocracked (designated HX) naptha which is naphtha that is derived by cracking longer chain hydrocarbons derived from the FT process product down to naphtha-range material using hydroconversion, which is then followed by fractionation
a combination HX and HT SR (designated GTL) naphtha

TABLE 3

| | Synthetic FT Naphthas | | | | Commercial | |
|---|---|---|---|---|---|---|
| | SR | HT SR | HX | LTFT | SA Diesel | Notes |
| ASTM D86 | | | | | | |
| IBP, ° C. | 58 | 60 | 49 | 54 | 182 | |
| T10, ° C. | 94 | 83 | 79 | 81 | 223 | |
| T50, ° C. | 118 | 101 | 101 | 101 | 292 | |
| T90, ° C. | 141 | 120 | 120 | 120 | 358 | |
| FBP, ° C. | 159 | 133 | 131 | 131 | 382 | |
| Density, kg/L | 0.7101 | 0.6825 | 0.6877 | 0.6852 | 0.8483 | |
| (20 ° C.) | | | | | | |
| Cetane Number | n/a | 42.7 | 30.0 | 39.6 | 50.0 | |
| Heat of Combustion, | 45 625 | 48 075 | 46 725 | 46 725 | 45 520 | note 2 |
| HHV, kJ/kg | | | | | | |
| Acid Number, mg | 0.361 | 0.001 | 0.011 | 0.006 | 0.040 | |
| KOH/G | | | | | | |
| Total sulphur, | <1 | <1 | <1 | <1 | 4 242 | |
| mg/L | | | | | | |
| Composition, % wt | | | | | | |
| n-paraffins | 53.2 | 90.1 | 28.6 | 59.0 | n/a | |
| Iso-paraffins | 1.2 | 8.3 | 66.7 | 38.2 | n/a | |
| Naphthenics | — | — | — | — | n/a | |
| Aromatics | — | 0.1 | 0.5 | 0.3 | n/a | |
| olefins | 35.0 | 1.5 | 4.2 | 2.5 | n/a | |
| alcohols | 10.7 | — | — | — | n/a | |
| Cloud Point, ° C. | −51 | −54 | −35 | −33 | 4 | |
| Flash Point, ° C. | −9 | −18 | −21 | −20 | 57 | note 3 |
| Viscosity | n/a | n/a | n/a | 0.50 | 3.97 | |

Notes:
1. These fuels contain no additives;
2. API Procedure 14A1.3;
3. Correlated (ref.: HP September 1987 p. 81)

Typically the concentration of C₄ and lighter hydrocarbons in GTL naphtha is extremely low, unless special storage precautions are taken to reduce loss by evaporation. This is governed by the fact that the boiling point of paraffinic hydrocarbons lighter than C₅ is significantly less than room temperature, with C₄ paraffins having a normal boiling point at −1° C. and C₅ paraffins boiling at approximately 36° C. Hence the naphtha fraction of interest in this invention will typically have a C₄ or lighter hydrocarbon content less than 1.0% by mass or even more typically less than 0.5% by mass.

Fraction that is C₄ and Lighter

Light hydrocarbon streams that are suitable for use in the practise of this invention will be predominantly C₄ or lighter; and may be a single hydrocarbon such as normal butane; or may be a blend of suitable hydrocarbons.

The C₄ or lighter hydrocarbon stream may be selected from a crude-derived source; an FT-derived source; or a combination thereof. It is further postulated that the increased olefin content of an FT-derived source could yield beneficial effects in terms of asphaltene stability/solubility. For example, C₃₋₄ olefins may comprise between 1 and 5 mass % of the total FT synthesis product (excluding inert gases and water gas shift product) and can more typically be between 2.5 and 4 mass %; whilst C₃₋₄ paraffins will typically comprise less than this (between 0.5 and 2 mass %) and can more typically be between 1.5 and 2% by mass. The mass ratio of olefins to paraffins in the C₃₋₄ range will hence typically be between 3:1 and 1.5:1; and can more preferably be approximately 2:1.

An example of a suitable composition for practising this invention would be field-grade or mixed butane, defined as a product consisting chiefly of normal butane and isobutane, such as that produced at a gas processing plant. Such a mixed butane typically consists of a mixture of isobutane, normal butane (with some propane, and small amounts of isopentane and normal pentane being present). Characteristically such a mixed butane consists of at least 60% by volume n-butane and approximately 20% by volume of isobutane, such that the overall combined butane content is at least 80% by volume. Field butane compositions typically result in increased volatility when compared with pure normal butane because of the presence of propane and other lighter hydrocarbons.

The light hydrocarbon stream of this invention may be an FT-derived hydrocarbon; which would hence enable the effective utilisation of more of the FT-derived products. In the case of an FT-derived light hydrocarbon fraction; a further method of introducing a significant quantity of C₄ or lighter hydrocarbon into the naphtha stream would be to choose the initial lower FT naphtha cut point to be lighter than is the case conventionally. This would allow for a suitable C₄ and lighter fraction without having to blend it in subsequently. It is noted that such a stream would require special handling/storage conditions in order to preserve the C₄ and lighter fraction for use in blending.

### Heavy Hydrocarbon/Diluent Stability

FT-derived hydrocarbon streams typically have aromatic contents much lower than 2% by volume. According to the Enbridge CRW pool diluent specifications (which are extensively used for determining diluent fit-for-purpose); if a proposed diluent has an aromatics content less than 2% by volume then compatibility testing must be carried out to demonstrate suitability.

Compatibility testing is carried out according to the well-accepted Wiehe test method as published by Wiehe in Energy Fuels, 2000, 14(1), pp 56-59. According to this method, the Wiehe solubility factors for non-solvent oils (SNSO) are determined by titrating a reference hydrocarbon with asphaltenes present with the proposed diluent non-solvent hydrocarbon. Non-solvent hydrocarbons will not contain any asphaltenes (such as the diluents proposed in this application). The reference heavy hydrocarbon used for this characterisation is an Athabasca heavy hydrocarbon. The SNSO value gives a very clear indication of the compatibility of the proposed diluent-heavy hydrocarbon system.

### Example

A blend of GTL-derived naphtha with a representative “field” butane sample at 5% by mass was produced. The compatibility of the pure GTL naphtha and the GTL naphtha/butane blend were then determined in accordance with the Wiehe test method. A standard diluent hydrocarbon reference sample was also assessed according to the test methodology. The SNSO results of this characterisation are shown in Tables 4 to 6.

TABLE 4
Results for GTL Naphtha

| COMPATIBILITY TEST | | | OTHER TESTS | | |
|---|---|---|---|---|---|
| Element | Result | Units | Element | Result | Units |
| DENSITY | 0.6787 | g/ml | DENSITY 15.6 C. | 0.6787 | g/ml |
| TEST (REF) OIL | QC ATHA | | TAN NUMBER | 0.01 | mg KOH/g |
| TE OF TEST OIL | 19 | % Tol | NITROGEN | 0.5 | mg/l |
| DENSITY OF TO | 1.0074 | g/ml | | | |
| VH OF TEST OIL | 10.1 | ml C7/5 ml | | | |
| VNSO | 9.1 | ml | | | |
| | | NSO/5 ml | | | |
| SNSO | −3.49 | | | | |

TABLE 5
Results for GTL naphtha blended 5% volume field butane

| COMPATIBILITY TEST | | | OTHER TESTS | | |
|---|---|---|---|---|---|
| Element | Result | Units | Element | Result | Units |
| DENSITY | 0.6737 | g/ml | DENSITY 15.6 C. | 0.6737 | g/ml |
| TEST (REF) OIL | QC ATHA | | TAN NUMBER | <0.001 | mg KOH/g |
| TE OF TEST Oil | 19 | % Tol | NITROGEN | 0.4 | mg/l |
| DENSITY OF TO | 1.0074 | g/ml | | | |
| VH OF TEST OIL | 10.1 | ml C7/5 ml | | | |
| VNSO | 9.1 | ml | | | |
| | | NSO/5 ml | | | |
| SNSO | −3.49 | | | | |

TABLE 6
Results for reference diluent sample

| COMPATIBILITY TEST | | | OTHER TESTS | | |
|---|---|---|---|---|---|
| Element | Result | Units | Element | Result | Units |
| DENSITY | 0.695 | g/ml | DENSITY-15.6 C. | 0.695 | g/ml |
| TEST (REF) OIL | QC ATHA | | TAN NUMBER | 41.4 | mg/L |
| TE OF TEST OIL | 19 | % Tol | NITROGEN | 0.03 | mg/KOH g |
| DENSITY OF TO | 1.0074 | g/ml | | | |
| VH OF TEST OIL | 10.1 | ml C7/5 ml | | | |
| VNSO | 10.9 | ml | | | |
| | | NSO/5 ml | | | |
| SNSO | 2.33 | | | | |

According to the Wiehe test methodology, the results of this analysis indicate that the GTL naphtha blend with field butane had the same compatibility with heavy hydrocarbons as did straight GTL naphtha. An SNSO value of −3.49 for both samples compares favourably with the reference diluent sample, indicating slightly lower compatibility than is the case for the reference diluent (which has an SNSO value of 2.33).

According to the Wiehe Oil Solubility Model, a theoretical assessment was then made of the blends with a MacKay bitumen at which compatibility limits will be reached, using the measured solubility data reported above. Because the GTL naphtha and its blend with butane had the same solubility number (SNSO), only one theoretical blend calculation was completed. The compatibility limit for the GTL naphtha and GTL naphtha/butane when blended with the bitumen were hence determined to be 64.5% naphtha, according to the results shown in Table 7. (The resulting P-values are reported—where P-values less than 1.0 are considered to be unstable.) For comparison purposes, the reference diluent sample has a compatibility limit of 68%.

In practise, the viscosity of the diluted bitumen is usually kept close to the upper pipeline injection limit of 350 cSt at 7.5° C., such that the typical lower blending threshold for the GTL naphtha/butane blend in this case would be approximately 31%.

GTL naphtha blended with 5% butane is hence determined to be compatible with bitumen in a blend of up to 64.5%; where levels of just 31% are required blended with MacKay bitumen in order to achieve viscosities that are required for transportation in a pipeline.

TABLE 7
Solubility Factors - GTL Naphtha & GTL naphtha/C4
blend with Mackay bitumen

| %-MacKay vol. | %-GTL vol. | SBN Mix | P-Value |
|---|---|---|---|
| 100.000 | 0.000 | 95.580 | 3.020 |
| 95.000 | 5.000 | 90.627 | 2.863 |
| 90.000 | 10.000 | 85.673 | 2.707 |
| 85.000 | 15.000 | 80.720 | 2.550 |
| 80.000 | 20.000 | 75.766 | 2.394 |
| 75.000 | 25.000 | 70.813 | 2.237 |
| 70.000 | 30.000 | 65.859 | 2.081 |
| 65.000 | 35.000 | 60.906 | 1.924 |
| 60.000 | 40.000 | 55.952 | 1.768 |
| 55.000 | 45.000 | 50.999 | 1.611 |
| 50.000 | 50.000 | 46.045 | 1.455 |
| 45.000 | 55.000 | 41.092 | 1.298 |
| 40.000 | 60.000 | 36.138 | 1.142 |
| 35.000 | 65.000 | 31.185 | 0.985 |
| 30.000 | 70.000 | 26.231 | 0.829 |
| 25.000 | 75.000 | 21.278 | 0.672 |
| 20.000 | 80.000 | 16.324 | 0.516 |
| 15.000 | 85.000 | 11.371 | 0.359 |
| 10.000 | 90.000 | 6.417 | 0.203 |
| 5.000 | 95.000 | 1.464 | 0.046 |
| 0.000 | 100.000 | −3.490 | −0.110 |

### REFERENCES

Oil Compatibility Model; as described in: Wiehe, Energy Fuels, 2000, 14(1), pp 56-59.

1-11. (canceled)

12. A process for making a heavy hydrocarbon feed pipeline transportable, comprising:
blending a heavy hydrocarbon feed with a diluent, the diluent comprising:
a hydrocarbon having at least 0.5% by mass of a C₄ or lighter hydrocarbon component; and
less than 2 vol % aromatics,
whereby a pipeline transportable heavy hydrocarbon feed and diluent blend is obtained, wherein a viscosity of the pipeline transportable heavy hydrocarbon feed and diluent blend is below 500 cSt at 7.5° C.

13. The process of claim 12, wherein the hydrocarbon of the diluent is a Fischer-Tropsch derived hydrocarbon.

14. The process of claim 12, wherein the diluent comprises less than 1 vol % aromatics.

15. The process of claim 12, wherein the diluent comprises less than 0.1 vol % aromatics.

16. The process of claim 13, wherein the Fischer-Tropsch-derived hydrocarbon is selected from a naphtha or diesel or a combination of the two.

17. The process of claim 12, wherein the diluent comprises at least 2 mass of a C4 or lighter hydrocarbon component.

18. The process of claim 12, wherein the diluent comprises 5 mass % or less of a C₄ or lighter hydrocarbon component.

19. The process of claim 12, wherein the C₄ or lighter hydrocarbon component is a Fischer-Tropsch derived hydrocarbon.

20. The process of claim 12, wherein the viscosity of the pipeline transportable heavy hydrocarbon feed and diluent blend is reduced below 350 cSt at 7.5° C.

21. A pipeline transportable heavy hydrocarbon feed and diluent blend, comprising:
a heavy hydrocarbon feed; and
a diluent, the diluent comprising:
a hydrocarbon having at least 0.5% by mass of a C₄ or lighter hydrocarbon component; and
less than 2 vol % aromatics,
wherein a viscosity of the pipeline transportable heavy hydrocarbon feed and diluent blend is below 500 cSt at 7.5° C.

22. The pipeline transportable heavy hydrocarbon feed and diluent blend of claim 21, wherein the diluent comprises 5 mass % or less of a C₄ or lighter hydrocarbon component.
